(19) United States
(12) Patent Application Publication
(10) Pub. No.: US 2005/0204357 A1
(43) Pub. Date: Sep. 15, 2005

(54) Mechanism to protect extensible firmware interface runtime services utilizing virtualization technology

(76) Inventors: Ajay Garg, Portland, OR (US); Pankaj N. Parmar, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/801,392

(22) Filed: Mar. 15, 2004

(51) Int. Cl. G06F 9/455

(52) U.S. Cl. 718/1

(57) ABSTRACT

A system and method is disclosed for protecting extensible firmware interface (EFI) runtime services utilizing virtualization technology. The runtime services used by an operating system (OS) are executed by a runtime services monitor (RSM) rather than the operating system itself. When the OS accesses a runtime service, the processor mode automatically switches context to the RSM, which then executes the runtime service and puts the results back in a shared memory location. Virtualization technology is used to effect the automatic context switching. Other embodiments as described and claimed above are disclosed.

### FIELD OF THE INVENTION

An embodiment of the present invention relates generally to computer systems and, more specifically, to protecting Extensible Firmware Interface (EFI) runtime services code and data from corruption and tampering.

### BACKGROUND INFORMATION

The Extensible Firmware Interface (EFI) is a specification which defines a new model for the interface between operating systems and platform firmware, commonly known as Basic Input Output System (BIOS). The specification version 1.10, published Dec. 1, 2002, is available at http://developer.intel.com/technology/efi/main_specification.htm. The interface consists of data tables that contain platform-related information, plus boot and runtime service calls that are available to the operating system and its loader. Together, these provide a standard environment for booting an operating system and running pre-boot applications.

The EFI specification is primarily intended for the next generation of Intel Architecture and Itanium® Architecture-based computers, and is an outgrowth of the “Intel Boot Initiative” (IBI) program that began in 1998. More information about EFI can be found at http://developer.intel.com/technology/efi/.

Legacy BIOS is tailored for a specific platform. EFI was developed to allow the operating system (OS) to operate generically and without communicating directly to the platform. EFI is effectively the middle layer between the OS and the platform. The layer beneath the EFI is implemented as BIOS, which is specific to the platform. The layer above EFI exposes the interface with which the OS communicates. When the system boots up and the OS assumes control, the OS is handed the EFI system table by the OS loader. The EFI system table is a data structure with pointers to other tables, or data structures. Some of these data structures contain a set of function pointers. The collections of functions pointed to by these tables are known as the runtime and boot services. Other data structures contain platform information such as the Advanced Configuration and Power Interface (ACPI) tables.

The runtime services comprise a set of functions that are available to the OS post-boot. Since the code and data that comprise the runtime services are loaded in the OS address space, the runtime services are open to compromise from malicious programs and hence protection from tampering, corruption or being overwritten is required. Because the functions are put into OS memory, the OS may easily call the functions. Because the functions become part of the OS, they can be destroyed or corrupted by a computer virus. The system table might also be corrupted by malicious code, or a bug in the OS. Corrupted function pointers can cause serious havoc with a system. If the OS tries to access the EFI runtime services table to retrieve a function pointer and execute the associated function, the pointers must be guaranteed to be valid. Therefore a mechanism to protect EFI runtime services is needed.

### BRIEF DESCRIPTION OF THE DRAWINGS

The features and advantages of the present invention will become apparent from the following detailed description of the present invention in which:

FIG. 1 is a block diagram of an exemplary virtualization platform having a Virtual Machine Control Structure (VMCS).

FIG. 2 is a block diagram of an exemplary system using an embodiment of a Funtime Services Monitor (RSM) as disclosed herein;

FIG. 3 is a block diagram illustrating the relationship between the EFI system table and the RSM according to an embodiment of the disclosed system and method;

FIG. 4 is a block diagram illustrating an embodiment having multiple Virtual Machines (VMs) and a RSM, integrated with a Virtual Machine Manager (VMM);

FIG. 5 is a block diagram illustrating the relationship between the multiple EFI system table instances, one per VM and a common RSM for all VMs integrated with the Virtual Machine Manager (VMM) according to an embodiment of the disclosed system and method which has more than one virtual machine (VM) running; and

FIG. 6 is a block diagram of an exemplary system environment in which an embodiment of the disclosed system and method may be practiced.

### DETAILED DESCRIPTION

If the operating system (OS) is not aware of or cannot access the memory holding the EFI system tables, then it cannot call functions in this memory. It also cannot purposefully or accidentally overwrite or corrupt the memory holding the EFI system tables. An embodiment of the present invention is a system and method relating to using platforms designed for accommodating virtualization in order to protect the EFI system table and related data structures/code in memory.

Reference in the specification to “one embodiment” or “an embodiment” of the present invention means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment.

A feature of a virtualization platform is that it allows execution of multiple Virtual Machines (VMs). A VM is an instance of a virtualized computer system with its own BIOS, memory, hard disk, network interfaces, OS, software applications etc. on a host system. The VM may be running any OS (usually referred to as a “Guest” OS), for example, Linux, Microsoft® Windows™ 2000, Windows™ XP, etc. A host system could be running multiple VMs with different hardware configuration, OS, applications etc. Platforms supporting virtualization may be considered an extension to the current Pentium® 4 family of processors available from Intel Corporation. These platforms provide for the distinction between a virtual machine monitor (VMM) and a virtual machine (VM). A VMM abstracts and virtualizes all of the hardware and presents the abstractions to different VMs.

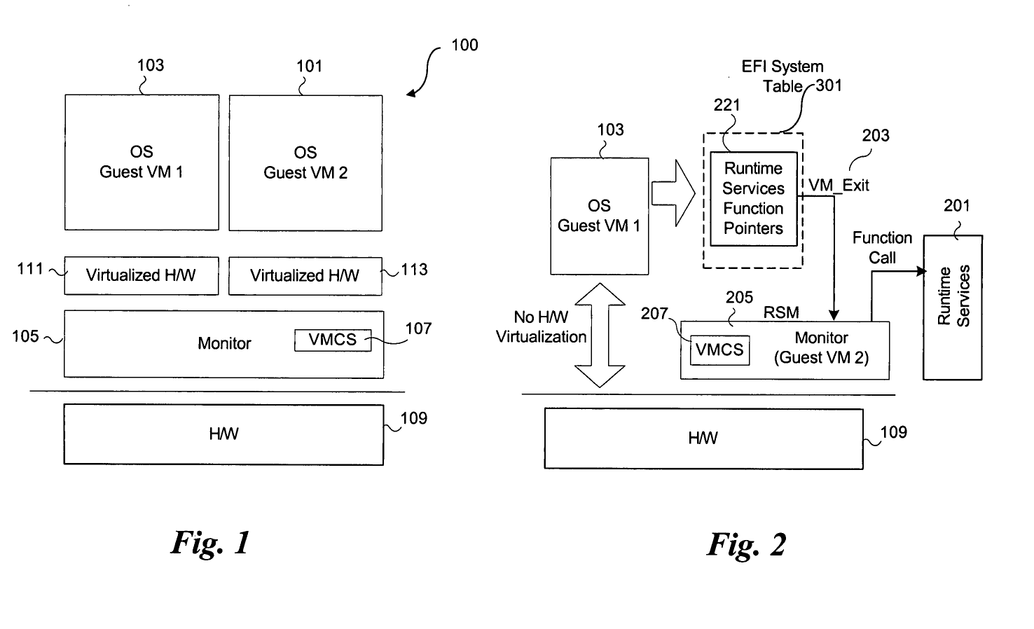

Referring now to the drawings, and in particular to FIG. 1, there is shown an exemplary computing platform running two virtual machines (VMs) 101 and 103. Each VM has a corresponding hardware virtualization layer 111 and 113. A monitor 105, also known as a virtual machine monitor (VMM), handles context switching between the two VMs 101 and 103. VMs may run in separate partitions on the host platform 100. Typically, the VMM is called the monitor 105 and the VMs are called guests. The monitor 105 provides abstractions to the hardware 109 to the guest VMs 101 and 103 and has privileges to control resource accesses by the guest VMs. In order to support virtualization, processors on Intel Architecture platforms may have support for Virtual Machine Extension (VMX) mode. Virtual Machine Extensions (VMX) allows creation of one or more Virtual Machines. VMX mode allows a processor executing in the context of a guest VM to switch control to the VMM based on certain operations performed by the guest VM software. A guest VM always runs in the VMX mode. The processor may use a data structure called Virtual Machine Control Structure (VMCS) 107 to determine the conditions under which the control must be transferred to the monitor 105. The criteria could be that whenever a guest VM requests access to certain memory addresses, I/O ports, or registers, the control will automatically switch to the monitor. While executing the guest software code, if the processor realizes that an instruction requires shift of control to the monitor, it generates a VM_exit event. VM_Exit is a condition which causes the processor to suspend execution of the guest software code and transfer control to the monitor.

In one embodiment, as shown in FIG. 2, there is only one VM 103 which is running a guest OS. The monitor 205 does not virtualize any hardware. The VMCS defines all instructions or memory accesses made by VM 103 which need control switchover to the monitor 205. The guest OS running in VM 103 is an EFI aware OS and makes calls to EFI runtime services. All EFI runtime service calls made by the OS on VM 103 are trapped and handled by the RSM 205. When the OS in VM 103 makes a call to a runtime service, the processor switches the context to RSM 205 via a call to VM_exit 203. The RSM 205 saves context and makes sure all memory boundaries and all the restrictions are followed as the switching happens from VM 103 to RSM 205. The runtime service 201 is then executed in the context of RSM 205. The results of the runtime service call 201 are copied back to a block of shared memory accessible by VM 103.

Effectively, there are three conceptual layers on any platform that supports EFI based platform firmware (or BIOS). The bottom layer is the firmware which is specific to the platform. The middle layer is the extensible firmware interface (EFI) which is independent of the platform. The top layer is the operating system (OS). In existing systems, there are several runtime services available to the OS. These include services such as: (a) getting the timer; (b) resetting the system; (c) halting the system; and (d) getting certain EFI variables.

It will be apparent to one of ordinary skill in the art that these services may be extended in the future to perform other functions, for instance, to access a network device. One reason there are few implemented runtime services is that there are few mechanisms for protecting them from corruption. The protection mechanism described herein may be extended to accommodate possible future runtime services.

Virtualization technology enables multiple virtual machines to execute simultaneously on the same platform. Some existing systems allow virtual machines to run on non-virtualized platforms with the help from virtualization software. In that case, a virtual machine monitor (VMM) takes care of many aspects of the system, including managing execution the virtual machines. As more virtual machines are added to the platform, overall system performance may suffer because of overhead required in switching between/among virtual machines and maintaining control over each VM. At some point more VMs cannot be added because the machine runs too slowly for desired tasks. In platforms with virtualization technology, a feature in hardware allows the system to switch between contexts faster. This capability provides hardware mechanisms to virtualization software.

In one embodiment a guest VM tries to access a disk. It appears to the guest VM that it owns the entire disk, but in reality the disk is being shared among VMs. The VMM arbitrates disk access by the one or more VMs. Any time such an access is attempted, an event is created called VM_Exit. This event is handled by the VMM. The VMM communicates with the actual hardware driver and passes the appropriate data to the VM. The VMM acts as a central unit to take care of all resource requests for all VMs. Controlled accesses may also include operating the keyboard and mouse which are shared among VMs, or even accessing memory.

In one example scenario, the VM tries to read a byte of data from the disk. The processor determines all of the parameters of the instruction. The processor may determine, for example, that the VM is trying to perform an IO_access or some other access. The VMCS may include a database that holds information regarding actions that must be handled by the VMM. For instance, if memory accesses to a specific block require a handoff to the VMM, then that block information will be stored in the VMCS. The processor checks with the VMCS to determine whether the operation requires control to be transferred to the VMM for processing. If the answer is yes, then the processor generates a VM_exit and the VMM assumes control.

In an embodiment, a VM runs in the VMX mode. Every instruction and memory access is verified by the VMCS. When not in VMX mode, the VMs are put on hold and the VMM is running. In VMX mode, the processor runs code in the context of a VM. The VMM effectively gives the time slices to the VMs.

Referring again to FIG. 2, in this embodiment, only two entities are running, a guest VM 103 and a runtime service monitor (RSM) 205. With only one VM running, virtualization of the hardware is not required, so the VM may directly access the hardware drivers.

The RSM 205 is a runtime service monitor which programs the VMCS 207 to include a set of addresses so the processor knows when to switch control from VM to RSM. In one embodiment, Guest VM 103 is executing code which requires a call to a runtime service. The runtime service function pointers are stored in the Runtime Services table 221 . The EFI system table 301 contains a pointer to the Runtime Services table 221 which comprises an array of function pointers such as, set time, get time, halt or reset the system. These runtime services are the functions that are desired to be protected. It may also be desirable to protect other portions of memory or code in this same fashion. There may also be data in the EFI system table which needs protection. The disclosed system and method may be applied to data in the EFI system table, as well.

If the VM 103 has direct access to the EFI system table 301 and corresponding runtime services 201, the VM could intentionally (or unintentionally) corrupt the code and/or data related to runtime services 201. In one embodiment, the VM 103 has access to the EFI system table 301 to access the function pointers 221, but the VM does not have direct access to the runtime services 201. In this embodiment, the boot loader loads the operating system. The boot loader then hands off a pointer to the EFI system table to the OS. The OS parses the EFI System table to execute the runtime services. In this embodiment, the guest OS (running in VM 103) is an EFI-aware OS. When the VM 103 tries to execute the runtime service 201 by accessing the function pointer 221, the call is captured by the processor VMCS 207 before the function call is executed. A VM_exit 203 is generated. For instance, the VMCS may be configured to generate a VM_exit for all memory accesses made by the VM within the memory blocks starting at addresses A and B. When a memory location in the block is accessed, the processor determines from the VMCS that this is a case where a VM_exit must be generated. Any time the OS, in this example, VM 103, tries to make a function call during runtime, all of the function pointers that are within the A and B address range cause a VM_exit to be generated. In systems with virtualization technology, this VM_exit may change the mode of the processor. In this embodiment, the switch allows the RSM 205 to take control of the computing platform. The RSM 205 executes the code for the runtime service 201 and places the results of the call into a shared memory portion (not shown). The RSM then switches back to VMX mode and lets the processor execute resume_VM execution. The OS in VM 103 retrieves the results of the runtime service, thereby not having direct access to the runtime service memory block.

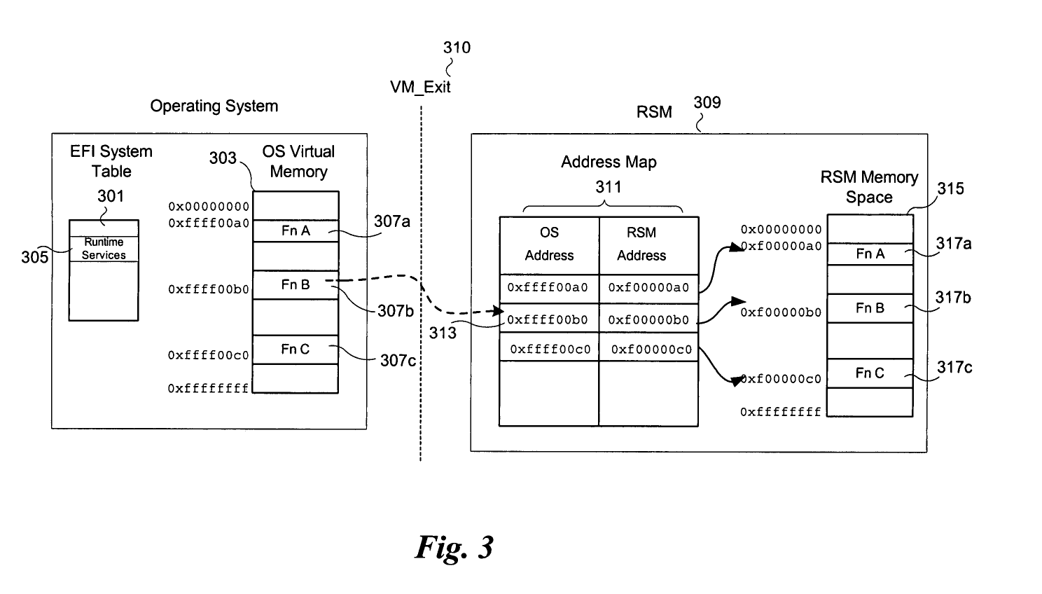

FIG. 3 shows the interaction between the RSM and the single VM. Since there is only one VM, the VMM does not do any virtualization of resources for the VM, but performs the function of the RSM. In one embodiment, when the guest VM calls the function Fn_A, the call results in the CPU executing the instruction to access memory location 0xffff00a0. The address 0xffff00a0, which is part of the OS address space 303, is the address of the function pointer of runtime service Fn_A. The processor automatically generates a VM_exit 310, as this address falls within a memory block range in the VMCS. Thus, when the OS attempts to access a runtime service using the function pointers 307a-c, a VM_exit 310 is generated and the system context is switched from VMX mode. The RSM 309 begins to execute the code appropriate to the runtime service selected. For instance, if the OS tried to execute Fn_B (307b) at virtual address 0xffff00b0, then the RSM 309 searches address map 311 for a corresponding RSM address 313 for virtual address 0xffff00b0. The RSM address points to protected RSM memory space 315. In the example of Fn_B address, RSM memory address 0xf00000b0 is accessed and Fn_B is executed. Since the OS has no direct access to functions A-C (317a-c), their code is protected from tampering. The results of Fn_B are put into a memory location accessible by the OS. When control is returned to the OS, the OS accesses the results of Fn_B as if control had never been switched to the VMM. In this embodiment, the virtualization is used to protect the runtime services, but not to enable more than one virtual machine on a platform.

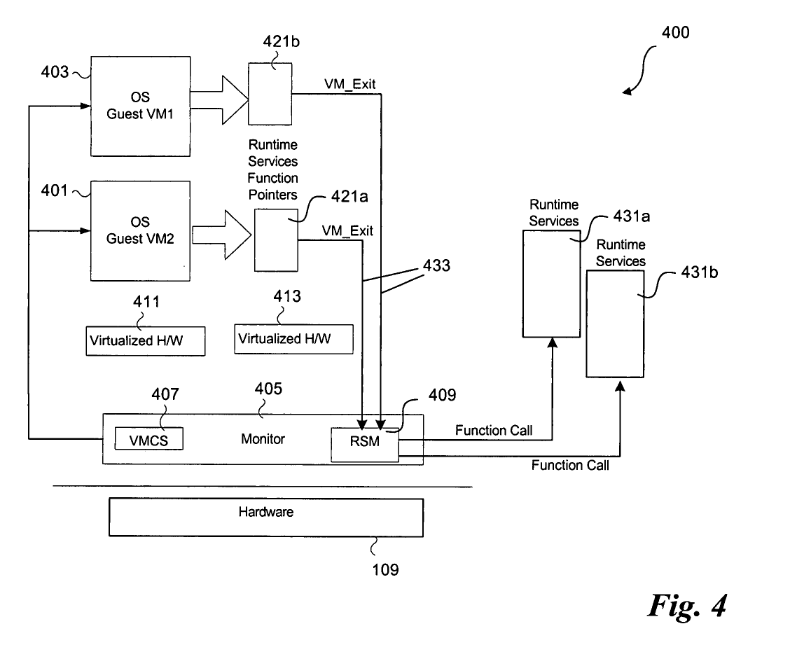

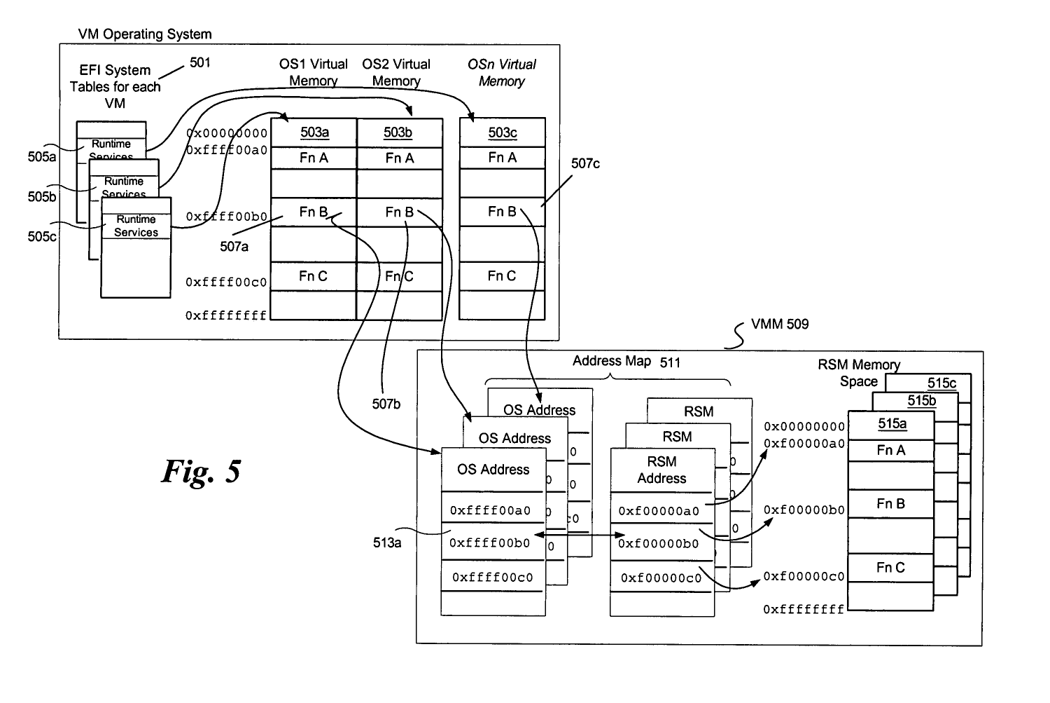

FIG. 4 illustrates another embodiment where multiple VMs are running simultaneously on platform 400. In this embodiment, Guest VM 1 (403) and Guest VM 2 (401) are both running on platform 400. Each VM has its own equivalent EFI based BIOS and a local copy of the EFI system table. The EFI system table owned by VM 1 (403) has runtime service function pointers 421b, and that owned by VM 2 (401) has runtime service function pointers 421a. Because there is more than one VM running, a more comprehensive monitor (VMM 405) arbitrates and controls resource usage. It may also be necessary to virtualize the hardware layer (411, 413) for VM 1 and VM 2. The monitor 405 has a VMCS 407, or similar control structure, which defines how the processor should react to access of memory locations associated with the runtime services. The monitor has a RSM 409 portion which takes control when a VM_exit 433 switches processor context from VMX mode to process a runtime service 431a-b.

FIG. 5 illustrates an exemplary memory structure for platforms with multiple VMs according to an embodiment of the disclosed system and method. EFI system tables 501 exist for each VM running in the platform. In this example, three EFI system tables are shown with corresponding runtime service pointers 505a-c. The runtime service pointers point to virtual memory locations 503a-c for their respective OSs. Runtime service Fn_B 507a-c, for instance, may exist for each VM OS. The VMM 509 has an address map 511 which correlates the OS address, for example, for Fn_B 513a to a RSM address. The RSM address points to RSM memory space 515a-c to correspond to the appropriate VM OS memory. It will be apparent to one of ordinary skill in the art that a variety of data structures, such as linked lists, arrays, object pointers, or other method, may be used to store the multiple EFI system tables and their corresponding address maps.

In the above described embodiments, when memory space is accessed, the processor mode is automatically switched from VMX to non-VMX mode using the VMCS table of addresses. A processor typically has a program counter (PC) which changes at every instruction. After executing an instruction, the PC moves to the next instruction, and so on. Every time the processor is about to execute an instruction, the processor knows what type of instruction is to be executed and how to execute it. The processor knows when to load registers, etc. In processors with virtualization technology, the processor compares the memory location (PC) with the range in the VMCS and if the location indicates a runtime service, a VM_exit is generated. The processor will then begin executing code in the context of the RSM. In other embodiments, the processor may not have automatic switching capability. In these embodiments an interrupt or other method may be used to switch contexts to the RSM. Switching modes may be implemented in different ways. While it is important to capture access to the memory range (function pointers) to automatically switch modes or contexts, the method used will not affect the capabilities of the disclosed system and method.

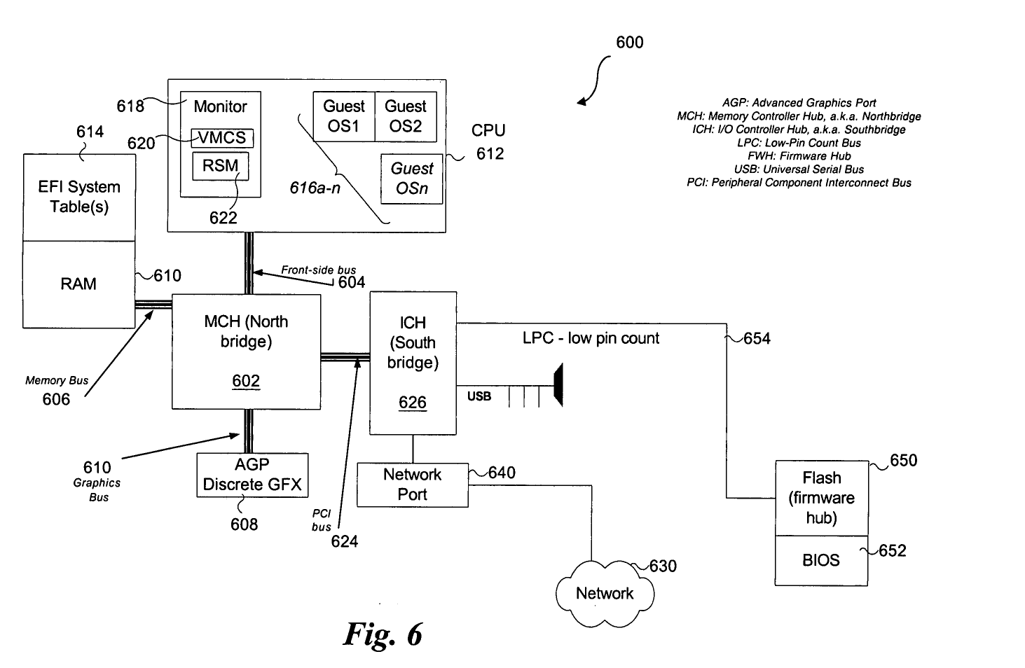

In one embodiment, FIG. 6 shows an exemplary block diagram of the computer system 600. Processor 612 communicates with a memory controller hub (MCH) 602, also known as Northbridge, via the front side bus 604. The MCH 602 communicates with system memory 610 via a memory bus 606. The MCH 602 may also communicate with an advanced graphics port (AGP) 608 via a graphics bus 610. The MCH 602 communicates with an I/O controller hub (ICH) 626, also known as Southbridge, via a peripheral component interconnect (PCI) bus 624. The processor 612 will typically communicate via a low pin count (LPC) bus 654 with a firmware hub 650 having BIOS 652 or other boot process. The processor may also communicate to a network 630 via a network port 640.

In one embodiment, the processor 612 executes one or more virtual machines (VMs) 616a-n in a virtualized environment. In this embodiment, system memory 610 holds EFI system tables 614 for the corresponding guest virtual machines (VMs) 616a-n. A monitor 618 controls resource access and execution of the VMs. The monitor 618 may have a VMCS control structure 620 which defines which resource accesses should switch control from a VM 616 to the monitor 618. If the resource access is for a runtime service, a RSM 622 may control execution of the requested runtime service before returning control to the requesting VM.

The techniques described herein are not limited to any particular hardware or software configuration; they may find applicability in any computing, consumer electronics, or processing environment. The techniques may be implemented in hardware, software, or a combination of the two. The techniques may be implemented in programs executing on programmable machines such as mobile or stationary computers, personal digital assistants, set top boxes, cellular telephones and pagers, consumer electronics devices (including DVD players, personal video recorders, personal video players, satellite receivers, stereo receivers, cable TV receivers), and other electronic devices, that may include a processor, a storage medium readable by the processor (including volatile and non-volatile memory and/or storage elements), at least one input device, and one or more output devices. Program code is applied to the data entered using the input device to perform the functions described and to generate output information. The output information may be applied to one or more output devices. One of ordinary skill in the art may appreciate that the invention can be practiced with various system configurations, including multiprocessor systems, minicomputers, mainframe computers, independent consumer electronics devices, and the like. The invention can also be practiced in distributed computing environments where tasks may be performed by remote processing devices that are linked through a communications network.

Each program may be implemented in a high level procedural or object oriented programming language to communicate with a processing system. However, programs may be implemented in assembly or machine language, if desired. In any case, the language may be compiled or interpreted.

Program instructions may be used to cause a general-purpose or special-purpose processing system that is programmed with the instructions to perform the operations described herein. Alternatively, the operations may be performed by specific hardware components that contain hardwired logic for performing the operations, or by any combination of programmed computer components and custom hardware components. The methods described herein may be provided as a computer program product that may include a machine accessible medium having stored thereon instructions that may be used to program a processing system or other electronic device to perform the methods. The term “machine accessible medium” used herein shall include any medium that is capable of storing or encoding a sequence of instructions for execution by the machine and that cause the machine to perform any one of the methods described herein. The term “machine accessible medium” shall accordingly include, but not be limited to, solid-state memories, optical and magnetic disks, and a carrier wave that encodes a data signal. Furthermore, it is common in the art to speak of software, in one form or another (e.g., program, procedure, process, application, module, logic, and so on) as taking an action or causing a result. Such expressions are merely a shorthand way of stating the execution of the software by a processing system cause the processor to perform an action of produce a result.

While this invention has been described with reference to illustrative embodiments, this description is not intended to be construed in a limiting sense. Various modifications of the illustrative embodiments, as well as other embodiments of the invention, which are apparent to persons skilled in the art to which the invention pertains are deemed to lie within the spirit and scope of the invention.

1. A system comprising:
a processor capable of running virtual machines, the processor having at least two modes of operation, wherein a first processor mode is to run a virtual machine;
memory operatively coupled to the processor, the memory storing a virtual management control structure (VMCS) to define authorized access to system resources;
a monitor to run in a second processor mode; and
means for automatically switching from the first processor mode to the second processor mode based on an attempted access of system resources defined in the VMCS.

2. The system as recited in claim 1, wherein the first processor mode is Virtual Machine Extension (VMX) mode.

3. The system as recited in claim 1, wherein the monitor is a runtime services monitor (RSM) to execute a runtime service on behalf of a virtual machine, the virtual machine to run in the first processor mode, wherein the RSM is to place results of the runtime service execution in a shared memory location accessible by the virtual machine.

4. The system as recited in claim 1, wherein the processor is to run more than one virtual machine.

5. The system as recited in claim 4, wherein the processor is capable of running a first virtual machine simultaneously with a second virtual machine where the virtual machines use different operating systems.

6. The system as recited in claim 1, wherein the monitor is to access at least one of data and instructions to be protected from the virtual machine.

7. A system for protecting system resources, comprising:
a processor having at least two modes of operation, wherein a first processor mode is to run a virtual machine and a second processor mode is to run a monitor;
a monitor to run in the second processor mode, wherein the monitor is to access system resources not deemed accessible by the virtual machine; and
at least one system resource, wherein an attempt to access at least one system resource by a virtual machine automatically switches the processor mode of operation from the first processor mode to the second processor mode and switches execution control to the monitor.

8. The system as recited in claim 7, wherein the at least one system resource corresponds to a runtime service, wherein the runtime service comprises at least one item selected from the group consisting of code and data.

9. The system as recited in claim 8, wherein the system resource comprises an address of a function pointer, wherein the function pointer points to the corresponding runtime service.

10. A method for protecting runtime services, comprising:
attempting access to a system resource by an operating system, wherein the operating system runs in virtual machine execution mode on a processor;
automatically switching the processor mode to monitor mode from virtual machine execution mode, in response to the attempted access;
accessing the system resource by the monitor; and
switching the processor mode back to virtual machine execution mode from monitor mode.

11. The method as recited in claim 10, wherein the system resource corresponds to a runtime service, and wherein the runtime service comprises at least one item selected from the group consisting of code and data.

12. The method as recited in claim 11, wherein the system resource comprises an address of a function pointer, wherein the function pointer points to the corresponding runtime service.

13. The method as recited in claim 11, further comprising:
executing the runtime service by the monitor; and
storing results of the runtime service in a shared storage location accessible by the operating system.

14. The method as recited in claim 11, wherein the operating system executes in a virtual machine.

15. The method as recited in claim 14, wherein more than one virtual machine is executing simultaneously on the processor.

16. The method as recited in claim 15, wherein the monitor is a virtual machine monitor having a runtime services monitor component.

17. A machine accessible medium having instructions that when executed result in the performance of the following:
attempting access to a system resource by an operating system, wherein the operating system runs in virtual machine execution mode on a processor;
automatically switching the processor mode to monitor mode from virtual machine execution mode, in response to the attempted access;
accessing the system resource by the monitor; and
switching the processor mode to virtual machine execution mode from monitor mode.

18. The machine accessible medium as recited in claim 17, wherein the system resource corresponds to a runtime service, and wherein the runtime service comprises at least one item selected from the group consisting of code and data.

19. The machine accessible medium recited in claim 18, wherein executing the instructions further performs:
executing the runtime service by the monitor; and
storing results of the runtime service in a shared storage location accessible by the operating system.

20. The machine accessible medium recited in claim 17, wherein the operating system is a virtual machine.

21. The machine accessible medium recited in claim 20, wherein more than one virtual machine is executing simultaneously on the processor.

22. The machine accessible medium recited in claim 21, wherein the monitor is a virtual machine monitor having a runtime services monitor component.
